(19) United States
(12) Patent Application Publication
(10) Pub. No.: US 2001/0010540 A1
(43) Pub. Date: Aug. 2, 2001

(54) Environment monitoring apparatus for vehicle

(75) Inventors: Hiroyuki Ogura, Shizuoka (JP); Kazutomo Fujinami, Shizuoka (JP)

Correspondence Address: ARMSTRONG, WESTERMAN, HATTORI,, MCLELAND & NAUGHTON, LLP, Suite 1000, 1725 K Street, N.W., WASHINGTON, DC, 20006, US

(73) Assignee: Yazaki Corporation, Tokyo (JP)

(21) Appl. No.: 09/769,277

(22) Filed: Jan. 26, 2001

(30) Foreign Application Priority Data
Jan. 31, 2000 (JP) 2000-22117

(51) Int. Cl. H04N 7/18

(52) U.S. Cl. 348/136; 348/148

(57) ABSTRACT

A picked-up image of an environment of the vehicle concerned is displayed. The position of an object which approaches the vehicle concerned is acquired on the basis of two picked-up images taken at times apart by a prescribed time interval. An immobile point on the approaching object is set. A display frame image is created with reference to the immobile point. The display frame image is superposed on the picked-up image. In such a configuration, since the approaching object is encircled by a display frame image, the approaching object can be easily visually recognized.

### BACKGROUND OF THE INVENTION

1. Field of the Invention

This invention relates to an environment monitoring apparatus, and more particularly to an environment monitoring apparatus which detects an approaching object on the basis of two images acquired by picking up the environment of the vehicle at two timings apart by a prescribed time and displays an image representative of the detected approaching object which is superposed on the picked-up image.

2. Description of the Related Art

Now referring to FIGS. 12A-12D, an explanation will be given of this environment monitoring system.

FIGS. 10A-10C are views for explaining a change in a rear image acquired by a video camera 1. FIG. 10A shows a status inclusive of the vehicle concerned. FIG. 10B shows an image picked up by a video camera 1 at timing t in an environment of the vehicle concerned. FIG. 10C shows an image picked up at timing t+Δt.

Now it is assumed that the vehicle concerned is running straight on a flat road. The road sign and building residing in the rear of the vehicle concerned in FIG. 11A are picked up as images shown in FIGS. 10B and 10C at timings t and t+Δt, respectively. The images are sequentially stored as pixel data with e.g. 512×512 pixels and luminances of 0-255 levels. By extracting the pixels with a prescribed or larger luminance difference from the neighboring pixels on the picked-up image, the characteristic points such as a contour of the other vehicle are extracted. Coupling the corresponding characteristic points in these two images provides speed vectors as shown in FIG. 12D. They are referred to as “optical flows”.

These optical flows appear radially from a point called an FOE (Focus of Expansion) within the image. The FOE is also referred to as a point at infinity or a disappearing point, and corresponds to a point in a direction directly opposite to the moving direction on the lane concerned when the vehicle runs straight. The optical flows acquired while the vehicle concerned runs are in the radial direction from the FOE. The optical flows which have been emitted from another vehicle running on the following or adjacent lane include the information of the position and relative speed of the vehicle running on the adjacent lane. It is known that the degree of danger is high when the optical flow is long and diverges from the FOE.

When the detected optical flow is long and diverges from the FOE, the conventional monitoring apparatus determines that there is an object (simply referred to as an approaching vehicle) approaching the vehicle concerned to provide a high degree of danger. On the basis of this determination, a warning indicative of the danger is issued, and the approaching vehicle is displayed on a display.

In some prior arts, a technique of searching corresponding points using two cameras is adopted. Specifically, a characteristic point Pa of an object is detected from a luminance difference between the adjacent pixels on the image picked up by a camera. A point Pb (not shown) of the image picked up by another camera corresponding to the detected characteristic point Pa (not shown) is detected. The position P of the approaching vehicle is computed by the pixel coordinates of Pa and Pb at prescribed time intervals. On the basis of the position of the approaching vehicle thus acquired, the driver of the vehicle concerned is given a warning of the existence of the vehicle approaching the vehicle concerned. In this case also, the approaching vehicle may be displayed on the display.

As seen from FIG. 13, the approaching other vehicle is displayed so that its characteristic points R are superposed on the picked-up image.

However, the characteristic points acquired at prescribed time intervals on the basis of the luminance difference as described above from the picked-up image with a background luminance changing constantly move for the approaching vehicle. Since plural characteristic points produced for a single approaching vehicle, it appears that a limitless number of points are moving on the image. In addition, although the plurality of characteristic points are generated for the single approaching vehicle, since they are very small points relative to the size of the approaching vehicle, the driver cannot visually recognize the approaching vehicle on the display at a glance.

Noting that the characteristic points are produced as a mass for the single approaching vehicle, it can be proposed to form a display frame F′ which encircles the mass of the characteristic points (see FIG. 13). However, since the size of the mass for the approaching vehicle varies according to a change in the occurrence of the characteristic points with a lapse of time, in this case also, the driver cannot recognize the approaching vehicle at a glance.

### SUMMARY OF THE INVENTION

An object of this invention is to provide an environment monitoring apparatus for a vehicle which can easily visually recognize an approaching object by encircling it using a display frame.

In order to attain the above object, in accordance with this invention, there is provided an environment monitoring apparatus for a vehicle comprising:

image pick-up means mounted on a vehicle for picking up an environment of the vehicle concerned to provide a picked-up image;

display means for displaying the picked-up image;

approaching object detecting means for detecting a position of an approaching object which is approaching the vehicle concerned on the basis of two picked-up images taken at two timings apart by a prescribed time;

immobile point setting means for setting an immobile point on the approaching object thus detected;

image creating means for creating a display frame image encircling the approaching object with reference to the immobile point; and

superposing means for superposing the display frame image on the picked-up image.

In this configuration, since the display frame image encircling the approaching object is formed with reference to the immobile point on the approaching object, the picked-up image encircled by a stable display frame can be displayed.

Preferably, the approaching detecting means comprises characteristic point extracting means for extracting a characteristic point or a mass of a plurality of characteristic points on the picked-up image at prescribed time intervals, the characteristic points or masses thereof on the two picked-up images being used to detect the position of the approaching object; and

the immobile point setting means sets the immobile point on the basis of the plurality of characteristic points appearing on the approaching object.

In this configuration, since the immobile point is set on the positions of the plurality of characteristic points appearing on the approaching object, the immobile point can be set using the characteristic points extracted in order to detect the approaching object on the picked-up image.

Preferably, the approaching object detecting means comprises means for detecting a quantity of movement of the same characteristic point or same mass of characteristic points on the two picked-up images so that the position of the approaching object on the picked-up image is detected on the basis of the detected quantity of movement.

In this configuration, the approaching object can be detected by a single image pick-up means.

Preferably, the immobile point setting means sets, as the immobile point, a central point or center of gravity of the plurality of characteristic points appearing on the approaching object.

In this configuration, since the averaged position of the plurality of characteristic points can be set as the immobile point, even if the characteristic points extracted at prescribed time intervals changes, the change is canceled to provide a substantially immobile point for the approaching object.

Preferably, the environment monitoring apparatus further comprises: white line detecting means for processing the picked-up image to detect a pair of white lines located on both sides of the lane concerned; and region setting means for regions of setting left and right adjacent vehicle lanes on the basis of the position of the white lines. The immobile setting means includes estimated locus setting means for setting an estimated locus of the immobile point on the approaching object within each of the left and right adjacent vehicle lane regions, sets an immobile vertical line on the approaching object on the basis of the horizontal positions of the characteristic points detected in each of the left and right adjacent lane regions and sets the crossing point of the immobile vertical line and the estimated locus as the immobile point.

In this configuration, where the approaching object vibrates vertically on the picked-up image because it runs on an uneven road, the immobile point can be set on the basis of only the horizontal positions of the characteristic points in the left or right adjacent lane region. Therefore, the display frame does not vibrate in synchronism with the vertical vibration of the approaching object.

Preferably, the image creating means creates a display frame having a size corresponding to the position of the immobile point on the picked-up image. Therefore, the display frame image corresponding to the size of the approaching object can be created.

Preferably, the environment monitoring apparatus for a vehicle, further comprises:

white line detecting means for processing the picked-up image to detect a pair of white lines located on both sides of the lane concerned; and

region setting means for setting regions of left and right adjacent vehicle lanes on the basis of the position of the white lines. The image creating means creates an enlarged display frame image as the horizontal position of the immobile point on the approaching object detected in the left or right adjacent lane region approaches the left or right end on the picked-up image.

In this configuration, the approaching object can be encircled by the display frame image which accurately corresponds to the size of the approaching object.

The environment monitoring apparatus for a vehicle comprises:

white line detecting means for processing the picked-up image to detect a pair of white lines located on both sides of the lane concerned; and region setting means for setting regions of left and right adjacent vehicle lanes on the basis of the positions of the white lines. The image creating means creates an enlarged display frame image as the vertical position of the immobile point on the approaching object detected in a region of the lane concerned approaches the lower end in the picked-up image.

In this configuration, the approaching object can be encircled by the display frame image which accurately corresponds to the size of the approaching object.

Preferably, the image creating means creates a provisional display frame image with reference to the immobile point set previously when the approaching object has not been detected, and the superposition means superposes the provisional frame display image on the picked-up image for a prescribed time.

In this configuration, even when the characteristic points cannot be extracted and detection of the approaching object is interrupted, the display frame of the approaching object can be display continuously.

The above and other objects and features of the present invention will be more apparent from the following description taken in conjunction with the accompanying drawings.

### BRIEF DESCRIPTION OF THE DRAWINGS

FIG. 1 is a schematic basic diagram of an environment monitoring system for a vehicle according to the present invention;

FIG. 2 is a block diagram of an embodiment of the environment monitoring system according to the present invention;

FIG. 3 is a flowchart showing the processing procedure of a CPU constituting the environment monitoring apparatus shown in FIG. 2;

FIG. 4 is a view showing the image picked up by a camera;

FIG. 5 is a view showing the differentiated image created by the processing of extracting the characteristic points from the picked-up image;

FIG. 6 is a view for explaining the operation of detection of white lines;

FIG. 7 is a view for explaining the operation of area setting;

FIGS. 8A and 8B are views for explaining the operation of detecting optical flows; and

FIG. 9 is a view of explaining the processing of detecting an approaching object;

FIG. 10 is a view showing the image displayed on the display;

FIG. 11 is a view for explaining the operation of setting an immobile point;

FIGS. 12A to 12D are views for explaining changes in the image acquired by the camera; and

FIG. 13 is a view for explaining the manner for displaying an approaching object (approaching vehicle) according to a prior art.

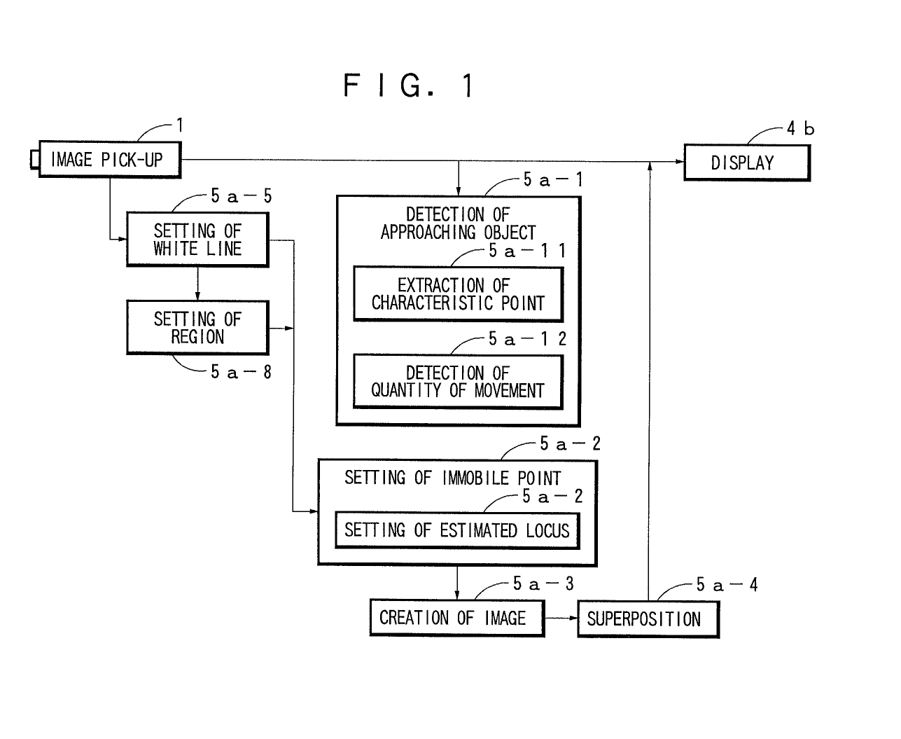

### DESCRIPTION OF THE PREFERRED EMBODIMENTS

Now referring to the drawings, an explanation will be given of various embodiments of the present invention.

Embodiment 1

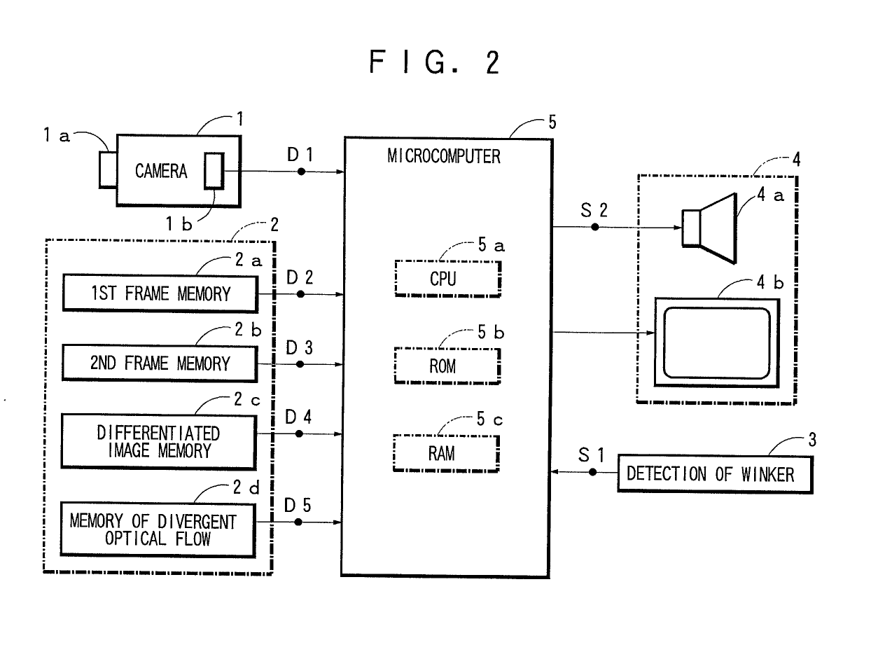

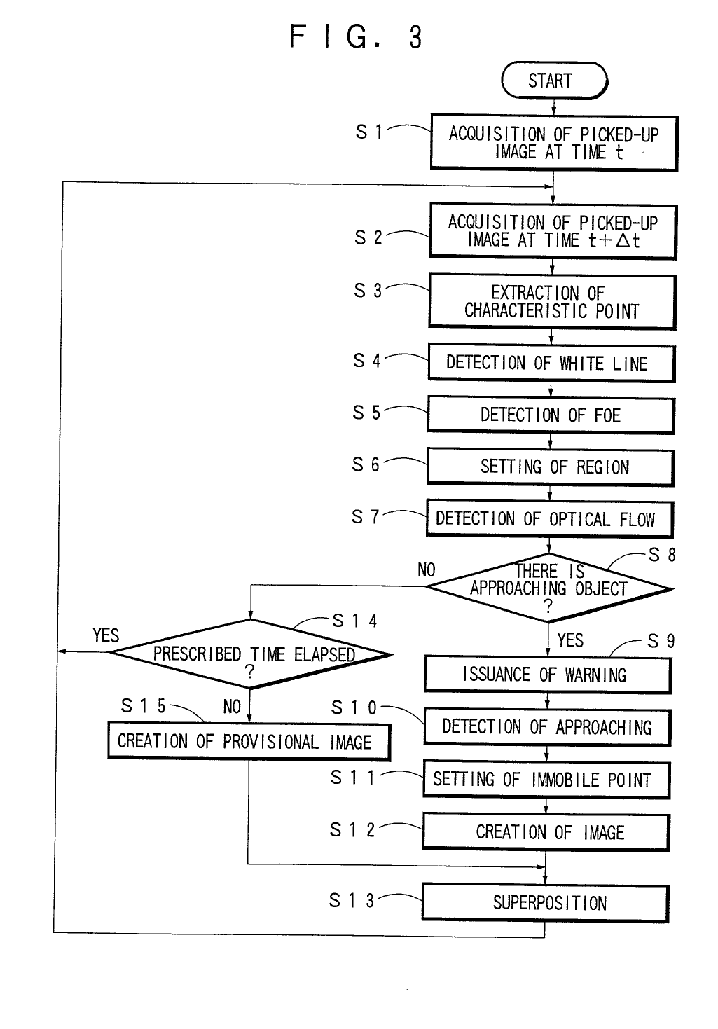

FIG. 2 is a block diagram of an embodiment of the environment monitoring system according to the present invention. As shown in FIG. 2, a camera 1 serving as an image pick-up means is loaded on a vehicle at a position permitting the environment of the vehicle concerned to be picked up. The camera 1 focuses an image over an angle of view defined by a lens 1a on an image plane 1b.

A storage section 2 includes a first frame memory 2a, a second frame memory 2b, a differentiated frame memory 2c and a divergent optical flow memory 2d. The first and the second frame memory 2a and 2b temporarily store, as D2 and D3, the pixels in a m- by n-matrix (e.g. 512×512 pixels and with the luminance in 0-255 levels) converted from the image data D1 imaged on the image plane 1b of the camera 1, and supplies them to a microcomputer 5.

The first frame memory 2a and second frame memory 2b successively store the m×n pixel data D2 and D3 converted from the image picked up at prescribed time intervals Δt in such a manner that it is stored in the first frame memory 2a at timing t, in the second frame memory 2b at timing t+Δt, . . . .

The differentiated image memory 2c stores the differentiated image data D4 created by differentiating the pixel data D2 and D3. The divergent optical flow memory 2d stores optical flow data D5 in a divergent direction and supplies them to the microcomputer 5.

The microcomputer 3 is connected to a winker detection switch 4. The winker detection switch, which is attached to a winker mechanism of a vehicle, supplies a winker signal S1 to turn instructing information S1 from the winker mechanism to the microcomputer 5. The winker mechanism is operated when by a driver when the vehicle concerned is turned around toward the right or left side.

The warning generating section 4 has a speaker 4a and display 4b which is a display means. The display 4b displays the picked-up image, or displays the image of the approaching vehicle encircled by a display frame on the picked-up image when it is decided that there is danger of contact with another vehicle which has abruptly approached the vehicle concerned, thereby informing the driver of the danger by an image. The speaker 5a indicates warning by a sound, i.e. generates audio guidance or warning on the basis of the sound signal S2 produced from the microcomputer 5 where it is decided that there is danger of collision or contact with another vehicle.

The microcomputer 5 includes a CPU 5a which operates in accordance with a control program, an ROM 5b for storing the control program for the CPU 5a and prescribed values, and RAM 5c for temporarily storing data necessary to perform computation of the CPU 5a.

An explanation will be given of the operation of an environment monitoring system having the configuration described above. First, the CPU 5a captures the picked-up image shown in FIG. 4 as picked-up data D1 from the camera 1. The CPU 5a causes the pixel data D2 corresponding to the image pick-up data Dl to be stored in the first frame memory 2a (step S1). The picked-up image is an image composed of a road 10, white lines drawn on the road 10 and walls extended upward on both sides of the road 10, which disappear at a central point in a horizontal direction on the image.

Since the camera 1 is attached rearward to the rear end of the vehicle as described above, with respect to the picked-up image shown in FIG. 4, its right side corresponds to the left side in the vehicle travelling direction whereas the left side corresponds to the right side in the vehicle travelling direction.

The CPU 5a causes the pixel data D3 of the image picked up at timing t+Δt to be stored in the second frame memory 2b (step S2). Thus, the pixel data D2 and D3 of the images picked up at prescribed intervals are sequentially stored in the first and the second frame memory 2a, 2b.

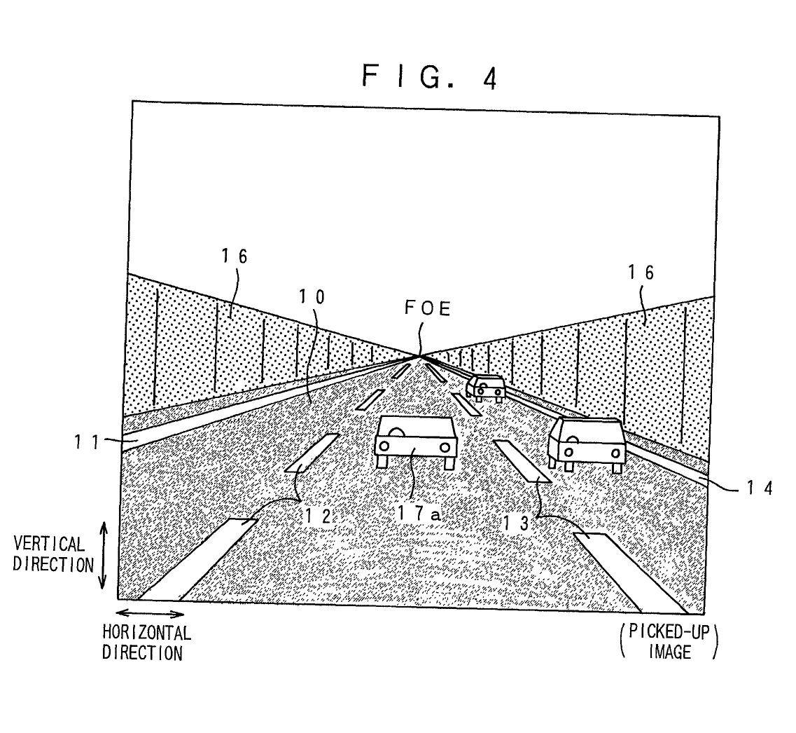

The CPU 5a performs the processing of extracting characteristic points (step S3) which will be described later. Through the processing by the CPU 5a, the pixel data D2 having the luminance of I m,n at the pixel at m-th row and n-th column are scanned horizontally in FIG. 4 so that a difference in luminance (Im,n+1−Im,n) between the pertinent pixel and an adjacent pixel is acquired. If it is larger than a prescribed value, luminance Imn=1 is taken. If it is smaller than the prescribed value, luminance Imn=0 is taken. The pixel data D2 are scanned vertically in the similar manner. On such an assumption, a differentiated image as shown in FIG. 5 is created which is the image composed of only the characteristic points representing the contour of the approaching vehicle on the picked-up image as shown in FIG. 5. In this case, the pixels each with the luminance of “1” set are extracted as the characteristic points. The differentiated image thus created is supplied as differentiated image data D4 to a differentiated image memory 2c. In step S3, the CPU 5a serves as means for extracting the characteristic points for the means for detecting the approaching object.

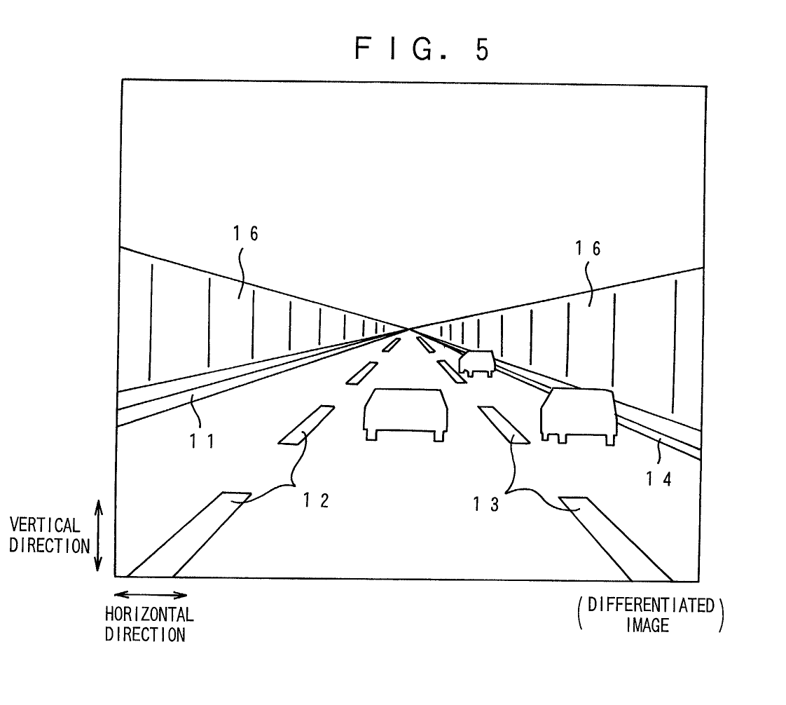

Next, the CPU 5a performs the processing of detecting the white line (step S4) which will be described below. First, a reference line V_{SL} as shown in FIG. 6 is set for the differentiated image. The reference line V_{SL} is set to run vertically on the differentiated image at a center position in the horizontal direction of the differentiated image. Namely, the reference line V_{SL} is set at a center in the horizontal direction of the lane on which the vehicle concerned runs and sectioned by the white lines 12 and 13.

After the reference line V_{SL} has been set, searching is carried out of the characteristic points of a pair of white lines 12 and 13 which are located on both sides of the lane concerned. Searching the characteristic points of the white lines 12 and 13 is carried out upward from a horizontal line H(_{LO}) located at the bottom of the screen shown in FIG. 6. The characteristic points are searched from the lowermost end P(_{S}₀) on the reference line V_{SL} toward both ends in the horizontal direction. Thus, the characteristic point P_{(LO)} constituting the edge of the white line 12 and the characteristic point P_{(R0)} constituting the edge of the white line 13 are acquired which are located on the left and right side of the reference line V_{SL}, respectively.

Next, the characteristic points are searched from the point P_{S1}, which is located at the second point from the lowermost end, toward both ends in the horizontal direction. Thus, the characteristic points P_{(L1)} of the white line 12 and P_{(R1)} of the white line 13 are acquired which are located on the left and right side of the reference line V_{SL}, respectively.

Such processing will be carried out successively upward to acquire the characteristic points on the differentiated image. In this case, the characteristic points P(_{L(m+2})), P(_{R(m+2})), P(_{L(m+2})), P(_{R(m+2})) of the vehicle following the vehicle concerned will be taken so that only the characteristic points on the same line are further extracted. As a result, only the characteristic points of the pair of white lines on both sides on the lane on which the vehicle concerned runs.

Approximated lines are created from the extracted characteristic points through the minimum square law, and detected as the white lines 12 and 13. Accordingly, the CPU 5a can operate as the white line detecting means.

The CPU 5a extends the approximated lines to set the crossing point as the FOE (FOE setting processing: step S5). In the FOE setting processing, the CPU 5a can operate as the FOE setting means. Likewise, the pixel data D3 of the image picked up after Δt are subjected to the characteristic point extracting processing, white-line extracting processing and FOE setting processing.

Next, the CPU 5a performs region setting processing (step S6) which will be explained below. First, it is carried out using the white lines 12 and 13 and the FOE set in step S5. As seen from FIG. 7, set are a right upper end line H_{UR} which is a boundary line extending rightward in a horizontal direction from the FOE and a left upper end line H_{UL} which is a boundary line extending leftward from the FOE in the horizontal direction. Using these right upper end line H_{UR}, left upper end line H_{UL} and white lines 12 (O_{L}) and 13 (O_{R}), a right adjacent lane region SV(_{R}), the lane concerned SV(S) and a left adjacent lane region SV(_{L}) are set. In the step S6, the CPU 5a can operate as the region setting means.

Next, the CPU 5a performs the optical-flow detecting processing of acquiring the turn instructing information Sl produced from the winker detecting unit 3 to detect the optical flow for the region corresponding to the turn instructing information S1. Specifically, where the turn instructing information S1 represents the will of changing the lane to the right adjacent lane, the optical flow is detected for the right adjacent lane region SV(_{R}). Where the above information represents the will of changing the lane to the left adjacent lane, the optical flow is detected for the left adjacent lane region SV(_{L}). Where the above information represents the will of not changing the lane, the optical flow is detected for the region of the lane concerned SV(_{S}).

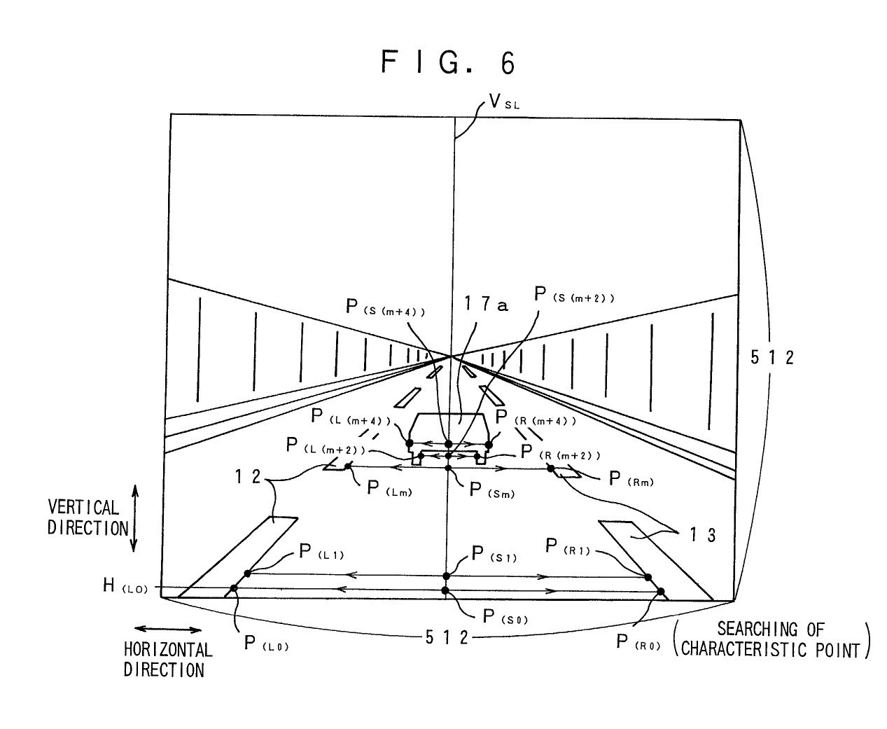

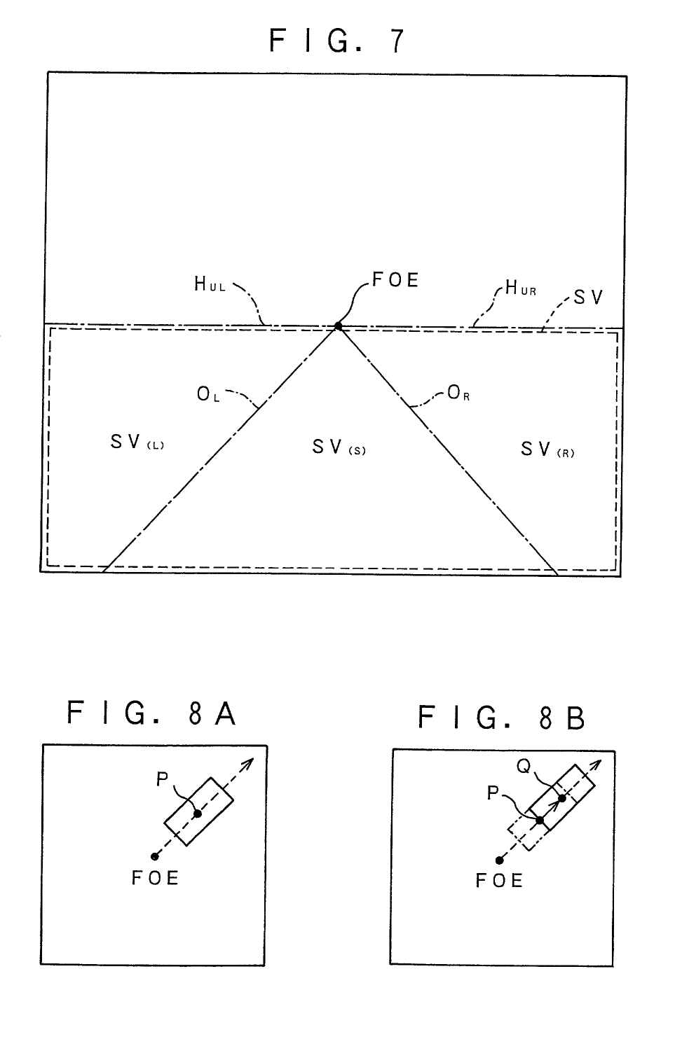

Referring to FIG. 8, the procedure of detecting the optical flow will be explained.

First, as shown in FIG. 8A, the pixel data D2 is acquired from the first frame memory 2a, and on the image picked up at timing t, a slender window is set around a certain characteristic point P in a radial direction of the FOE set as described above (i.e. in the direction of connecting the FOE 1 to the characteristic point P). Subsequently, the pixel data D3 is acquired from the second frame memory 2b, and on the image picked up at timing t+tΔ, while the window is shifted one point by one point in the radial direction from the FOE, the absolute value of the luminance difference is computed between each of the pixels constituting the window at timing t and each of the corresponding pixels constituting the window at timing t+Δt.

Namely, the absolute value of the luminance difference is computed between the characteristic point P at timing t (FIG. 8A) and the characteristic point Q at timing t+Δt. The quantity of movement of the window when the total sum of the luminance differences thus computed is minimum is taken as the optical flow of the characteristic point P at issue. The above processing is repeated for all the characteristic points according to the turn instructing information S1, thereby providing the optical flows within the region. In step S7 of detecting the white line, the CPU 5a can operate as the movement quantity detecting means. Incidentally, in FIGS. 8A and 8B, although the quantity of movement of the single characteristic point at issue was acquired as the optical flow, the quantity of movement of the pack of a plurality of characteristic points may be taken as the optical flow.

Next, the CPU 5a determines whether or not there is an approaching object such as another vehicle on the basis of the optical flows acquired in step S7 (step S8). If the optical flow converges toward the FOE, it means that another vehicle running on the adjacent lane or following the vehicle concerned on the same lane is running at a lower speed than that of the vehicle concerned and therefore leaving from the vehicle concerned. In contrast, if the optical flow diverges from the FOE, it means that the object is approaching the vehicle concerned.

The optical flows which are produced by the scene in the picked-up image or mark on the road all converge on the FOE. Therefore, these objects can be discriminated from the other vehicle approaching on the adjacent lane or following the vehicle concerned. The length of the optical flow produced from the other adjacent or following vehicle is proportional to its speed relative to the vehicle concerned. Therefore, if the length of the optical flow diverging from the FOE exceeds a prescribed length, it is determined that the other vehicle is abruptly approaching the vehicle concerned (YES instep S8). In order to inform the driver of this fact, a warning “there is an approaching vehicle” is issued by sound from e.g. the speaker 5a (step S9).

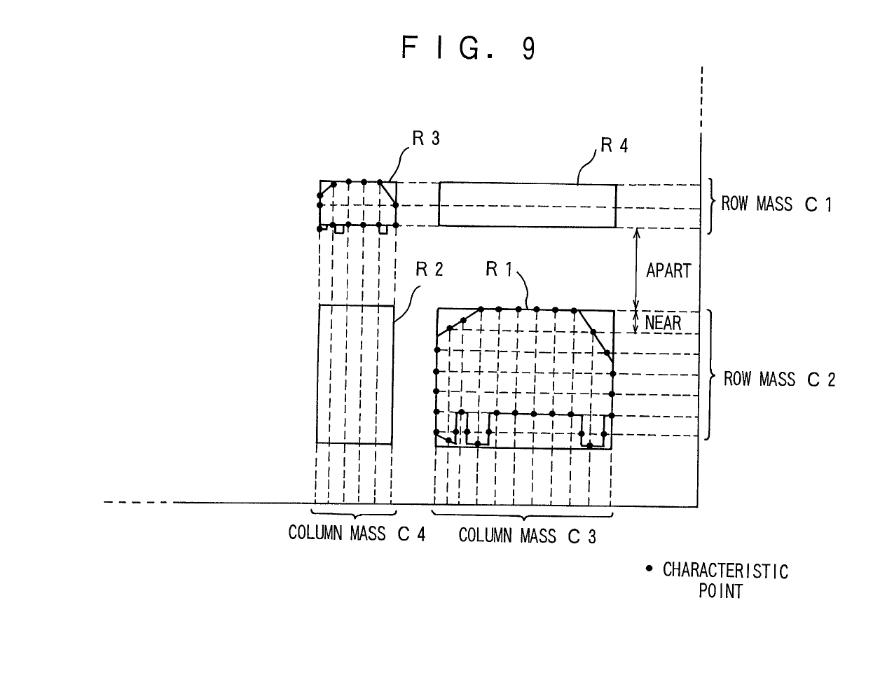

Next, the processing of detecting an approaching object is performed on the basis of the optical flows detected in step S7 (step S10). In this processing, the position of the approaching object on the picked-up image is detected. Referring to FIG. 9, an explanation will be given of the processing of detecting the approaching object. Incidentally, the explanation will be made of the case where the turn instructing information S1 represents the will of changing the lane concerned to the right adjacent lane, i.e. where the optical flows are detected for only the right adjacent lane region.

As seen from FIG. 9, the characteristic points constituting the optical flow exceeding a prescribed length are detected. As shown, a large number of characteristic points can be detected for a single approaching vehicle as a mass having a certain size. On the basis of this fact, masses of the characteristic points can be detected. If there is only a single mass of characteristic points, it means that there is another single approaching vehicle. If there are two masses of characteristics, it means that there are two approaching vehicles. It can be determined that the approaching vehicle has been picked up within a range where the mass(s) are present.

The method of detecting the mass of characteristic points will be explained. First, the CPU 5a extracts the rows and columns where the characteristic points are present on the picked-up image. On the basis of the distance between the extracted rows, a row mass (s) is detected. Likewise, the column mass(s) is also detected. In FIG. 9, row masses C1 and C2 and column masses C3 and C4 are detected. The ranges R1, R2, R3 and R4 when the row masses C1, C2 and the column masses intersect each other are acquired. In addition, it is decided that an approaching object have been picked up in each of the ranges R1 and R3 within which the characteristic points are actually present. In the step of detecting the approaching object, the CPU 5a operates as an approaching object detecting means.

Next, the CPU 5a performs the processing of setting an immobile point on the approaching object on the basis of the positions of the characteristic points within the regions R1 and R3 (step S1). For example, the central point or the center of gravity is set as the immobile point on the approaching object. The central point or the center of gravity represents an averaged point of the positions of the characteristic points. Therefore, even when there is a change in the characteristic points extracted according to timings, the change is canceled so that the point which does not almost mobile for the approaching object can be obtained. In step S11 of setting the immobile point, the CPU 5a operates as an immobile point setting means.

Next, the CPU 5a performs the image creating processing of creating a display frame image around the immobile point acquired by the immobile point setting processing, which encircles the approaching object in the picked-up image (step S12). The image creating processing for the left and right adjacent lane regions will be explained (step S12). On the picked-up image, it can be seen from FIG. 4 that the approaching vehicle running on the left or right adjacent lane approaches the left or right end of the image as it approaches the vehicle concerned. The approaching object is picked up with a larger size as it approaches the vehicle concerned.

Noting the above fact, as the position of the immobile point in the horizontal direction on the approaching object approaches the left or right end, the display frame is increased and the display frame image around the immobile point is created. Thus, the display frame can be increased in synchronism with the size of the approaching object on the picked-up image. Therefore, in the left or right adjacent lane region, the visibility of the approaching object can be further improved.

An explanation will be given of the image creating processing for the lane concerned. On the picked-up image, the vehicle following the vehicle concerned on the same lane approaches the lower end of the picked-up image as it approaches the vehicle concerned (not shown). The approaching object is picked up with a larger size as it approaches the vehicle concerned.

Noting the above fact, as the position of the immobile point in the vertical direction on the approaching object approaches the lower end of the picked-up image, the display frame is increased and the display frame image around the immobile point is created. Thus, the display frame can be increased in synchronism with the size of the approaching object on the picked-up image. Therefore, in the region of the lane concerned also, the visibility of the approaching object can be further improved.

Further, the CPU 5a performs superposition processing of superposing the display frame image created by the image creation processing on the picked-up image (step S13). In this step, the CPU 5a operates as superposition means which can display on the display 4b the image in which the approaching vehicle on the picked-up image is encircled by a display frame F11 around an immobile point D1.

After the superposition processing, the process of processing is returned to step S2.

If the presence of the approaching object is not detected in step S8 (NO in step S8), it is determined whether or not a predetermined time has elapsed from when the presence of the approaching object has been recognized previously (NO in step S8). If the predetermined time has not elapsed from when the presence of the approaching object was recognized previously (NO in step S14), the display frame image formed in the previous step S12 is set as a provisional display frame image. The process of processing proceeds to step S13.

By the processing of step S15, the provisional display frame image is superposed on the picked-up image until the predetermined time elapses from when no approaching vehicle was not recognized. Therefore, even when no characteristic point is extracted and detection of the approaching vehicle is interrupted, the display frame of the approaching vehicle is displayed continuously. Incidentally, in step S15, the immobile point on the present approaching object may be estimated on the immobile point set on the basis of the immobile point by the previous immobile point setting processing to create a provisional display frame image with respect to the estimated frame.

As described above, since the display frame image is created around the immobile point on the approaching object, even if the plurality of characteristic points appearing on the approaching object vary according to prescribed timings, the image with the approaching object encircled by a stable display frame can be displayed. This makes it easy to recognized the approaching object.

Embodiment 2

While the approaching vehicle runs on an uneven road, it may vibrate vertically. Therefore, as in the first embodiment, where the central point or center of gravity of the characteristic points is set as the immobile point and the display frame image is created around the immobile point, the display frame image vibrates vertically in synchronism with the vertical vibration of the approaching object. When the display frame image vibrates vertically, the display frame is difficult to see so that it is difficult to recognize the approaching vehicle. In order to solve this problem, the processing of setting the immobile point for the left and right adjacent lane region SV(_{L}) and SV(_{R}) may be performed as follows.

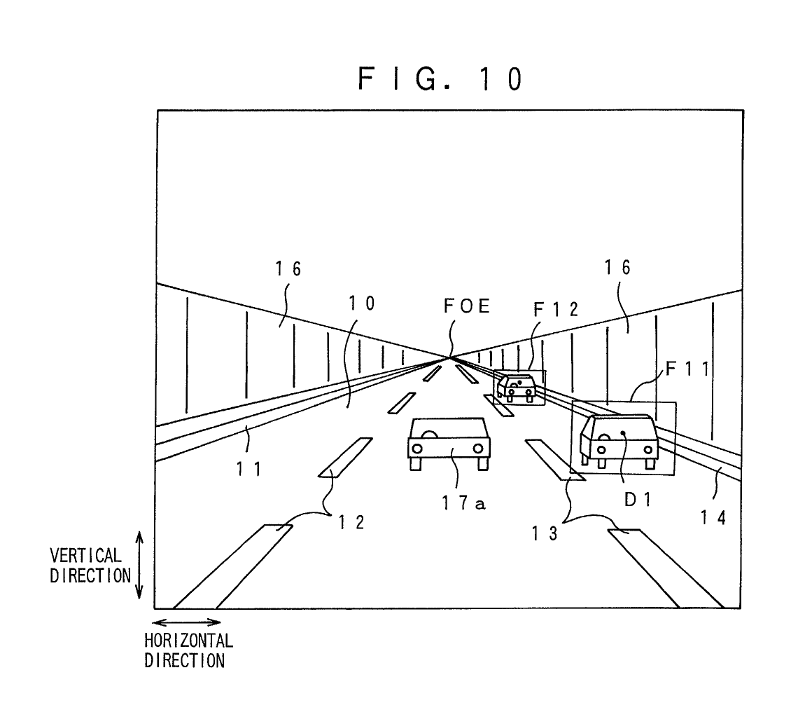

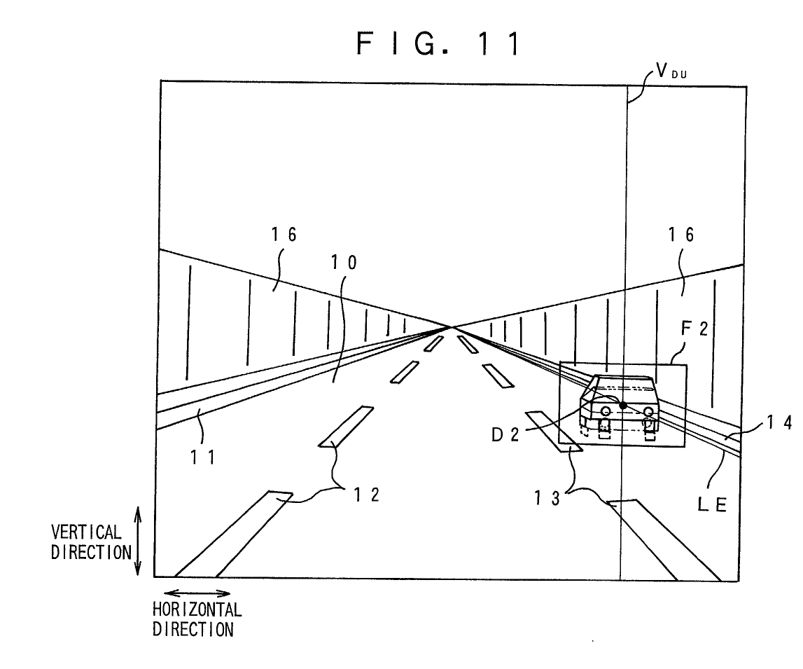

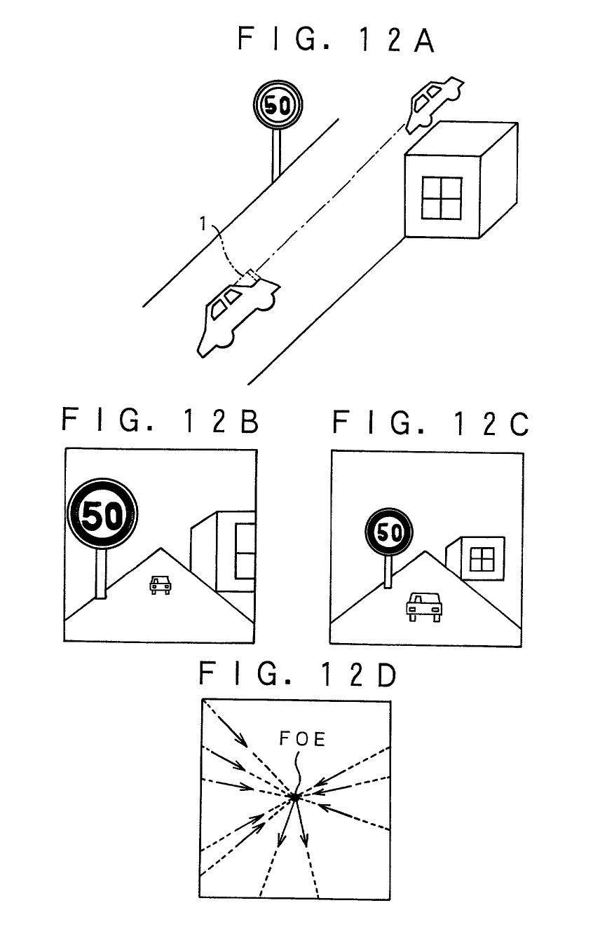

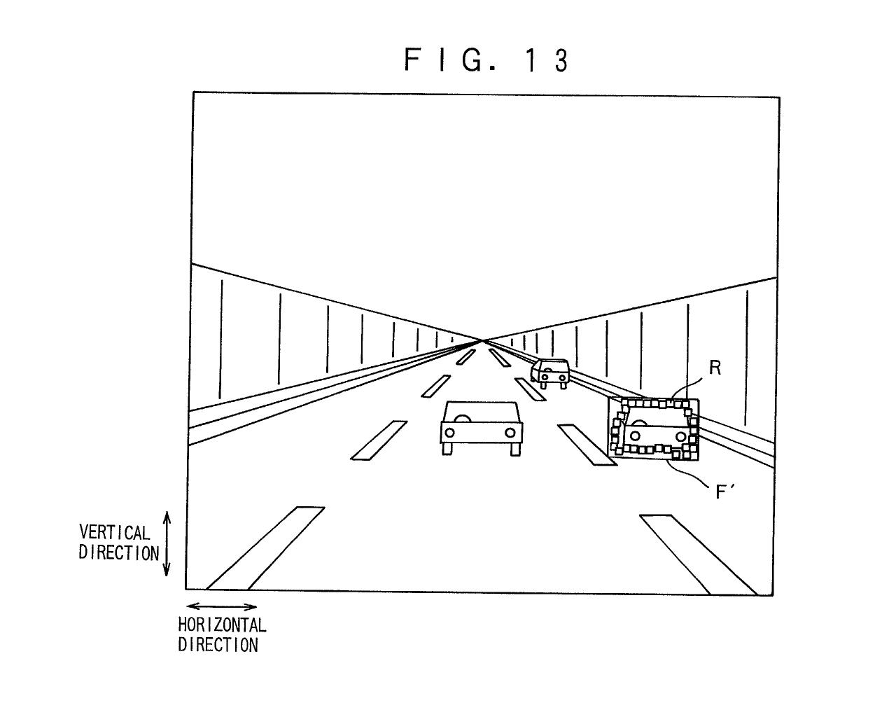

First, as shown in FIG. 11, an immobile vertical line V_{UD} on the approaching vehicle is set using the plurality of characteristic points in the horizontal direction. The immobile vertical line VUD may be e.g. a vertical line passing the central point or center of gravity of the plurality of characteristic points. The central point or center of gravity is an averaged point of the characteristic points in the horizontal direction. Therefore, even when the extracted characteristic points are changed, the change is canceled so that a point on the immobile vertical line V_{UD} which is substantially immobile for the approaching object can be obtained.

Next, an estimated locus L_{E} of the immobile point on the approaching object detected in the left or right adjacent lane regions SV(_{L}) or SV(_{R}) is set on the basis of e.g. the position of the white line or the position of the FOE. The crossing point of the immobile vertical line V_{UD} and the estimated locus L_{E} is set as an immobile point D2. A display frame image F2 is created around the immobile point D2. In this way, since the immobile point can be set on the basis of only the horizontal positions of the characteristic points, the display frame does not vibrate vertically according to the vertical vibration of the approaching vehicle, thereby providing a stable display frame image on the image picked up.

In the first embodiment, although the central point or center of gravity of the plurality of characteristic points of the approaching vehicle was set as the immobile point, for example, as long as prescribed time interval Δt is minute, the averaged position of the central points or centers of gravity computed several times at prescribed intervals Δt may be set as an immobile point.

Further, in the first and the second embodiment, the approaching vehicle was detected by detecting the quantity of movement of the same characteristic point in the two images picked up at times apart by a prescribed time. However, the invention can be applied to the case where a still another vehicle approaching the approaching vehicle is detected using two cameras. It should be noted that this case requires high cost because the two cameras are used.

What is claimed is:

1. An environment monitoring apparatus for a vehicle comprising:
image pick-up means mounted on a vehicle for picking up an environment of the vehicle concerned to provide a picked-up image;
display means for displaying the picked-up image;
approaching object detecting means for detecting a position of an approaching object which is approaching the vehicle concerned on the basis of two picked-up images taken at two timings apart by a prescribed time;
immobile point setting means for setting an immobile point on the approaching object thus detected;
image creating means for creating a display frame image encircling the approaching object with reference to the immobile point; and
superposing means for superposing the display frame image on the picked-up image.

2. An environment monitoring apparatus for a vehicle according to claim 1, wherein the approaching detecting means comprises characteristic point extracting means for extracting a characteristic point or a mass of a plurality of characteristic points on the picked-up image at prescribed time intervals, the characteristic points or masses thereof on the two picked-up images being used to detect the position of the approaching object; and
the immobile point setting means sets the immobile point on the basis of the plurality of characteristic points appearing on the approaching object.

3. An environment monitoring apparatus for a vehicle according to claim 1, wherein the approaching object detecting means comprises means for detecting a quantity of movement of the same characteristic point or same mass of characteristic points on the two picked-up images so that the position of the approaching object on the picked-up image is detected on the basis of the detected quantity of movement.

4. An environment monitoring apparatus for a vehicle according to claim 2, wherein the immobile point setting means sets, the immobile point, a central point or center of gravity of the plurality of characteristic points appearing on the approaching object.

5. An environment monitoring apparatus for a vehicle according to claim 3, wherein the immobile point setting means sets, the immobile point, a central point or center of gravity of the plurality of characteristic points appearing on the approaching object.

6. An environment monitoring apparatus for a vehicle according to claim 2, further comprising:
white line detecting means for processing the picked-up image to detect a pair of white lines located on both sides of the lane concerned; and
region setting means for setting regions of left and right adjacent vehicle lanes on the basis of the position of the white lines,
wherein the immobile setting means includes estimated locus setting means for setting an estimated locus of the immobile point on the approaching object with each of the left and right adjacent vehicle lane regions, sets an immobile vertical line on the approaching object on the basis of the horizontal positions of the characteristic points detected in each of the left and right adjacent lane regions and sets the crossing point of the immobile vertical line and the estimated locus as the immobile point.

7. An environment monitoring apparatus for a vehicle according to claim 3, further comprising:
white line detecting means for processing the picked-up image to detect a pair of lines located on both sides of the lane concerned; and
region setting means for setting regions of left and right adjacent vehicle lanes on the basis of the position of the white lines,
wherein the immobile setting means includes estimated locus setting means for setting an estimated locus of the immobile point on the approaching object with each of the left and right adjacent vehicle lane regions, sets an immobile vertical line on the approaching object on the basis of the horizontal positions of the characteristic points detected in each of the left and right adjacent lane regions and sets the crossing point of the immobile vertical line and the estimated locus as the immobile point.

8. An environment monitoring apparatus for a vehicle according to claim 1, wherein the image creating means creates a display frame having a size corresponding to the position of the immobile point on the picked-up image.

9. An environment monitoring apparatus for a vehicle according to claim 8, further comprising:
white line detecting means for processing the picked-up image to detect a pair of white lines located on both sides of the lane concerned; and
region setting means for setting regions of left and right adjacent vehicle lanes on the basis of the position of the white lines,
wherein the image creating means creates an enlarged display frame image as the horizontal position of the immobile point on the approaching object detected in the left or right adjacent lane region approaches the left or right end on the picked-up image.

10. An environment monitoring apparatus for a vehicle according to claim 8, further comprising:
white line detecting means for processing the picked-up image to detect a pair of white lines located on both sides of the lane concerned; and
region setting means for setting left and right adjacent vehicle lanes on the basis of the positions of the white lines,
wherein the image creating means creates an enlarged display frame image as the vertical position of the immobile point on the approaching object detected in a region of the lane concerned approaches the lower end in the picked-up image.

11. An environment monitoring apparatus for a vehicle according to claim 1, wherein the image creating means creates a provisional display frame image with reference to the immobile point set previously when the approaching object has not been detected, and the superposition means superposes the provisional frame display image on the picked-up image the for a prescribed time.
